(19) United States
(12) Patent Application Publication
(10) Pub. No.: US 2023/0310272 A1
(43) Pub. Date: Oct. 5, 2023

(54) SEMI-RIGID BIOCONTAINER AND METHODS OF MANUFACTURING THE SAME

(71) Applicant: Sartorius Stedim North America Inc., Bohemia, NY (US)

(72) Inventors: Michael Zumbrum, New Oxford, PA (US); William Kimmick, Mechanicsburg, PA (US); Kevin Perdue, Havre de Grace, MD (US)

(73) Assignee: Sartorius Stedim North America Inc., Bohemia, NY (US)

(21) Appl. No.: 18/127,140

(22) Filed: Mar. 28, 2023

Related U.S. Application Data
(60) Provisional application No. 63/325,202, filed on Mar. 30, 2022.

(51) Int. Cl. A61J 1/16; A61J 1/14

(52) U.S. Cl. CPC A61J 1/165; A61J 1/1475; A61J 1/1468; B33Y 80/00

(57) ABSTRACT

A biocontainer including a rigid frame and a flexible membrane. The frame includes a lattice core. The membrane may flex to adjust to a volume of biomaterial sealed within the interior of the biocontainer as a temperature of the biomaterial changes.

### CROSS-REFERENCE TO RELATED APPLICATION

This application claims the benefit of, and priority to, U.S. Provisional Patent Application Ser. No. 63/325,202, filed Mar. 30, 2022, the entire contents of which are hereby incorporated by reference.

### BACKGROUND

### 1. Technical Field

The present disclosure relates to storage of biopharmaceutical compositions and, more specifically, to semi-rigid biocontainers and methods of manufacturing the same.

### 2. Discussion of Related Art

Frozen storage is a key step in production of biopharmaceutical compositions including monoclonal antibodies, vaccines, cell banks, virus banks, and cell therapy products. By immobilizing the macromolecules, cells, or virus particles in a solid matrix, stability of the biopharmaceutical compositions can be extended enabling more efficient manufacturing operations, global transport, and long-term availability.

The use of polymeric single-use containers (bags, bottles, tubing, and components such as connectors) at temperatures in the range −20° C. to −196° C. is a significant challenge requiring careful attention to material selection and packaging. For example, as biopharmaceutical compositions (hereinafter “biomaterial”) are frozen, the volume of the biomaterial may increase or decrease. The change in volume can exert forces on the biocontainer. In addition, as the biocontainer is frozen, the properties of the materials forming the biocontainer may change. Some materials that form the biocontainers may become less flexible and/or become brittle.

In some applications, materials forming a biocontainer may create a challenge for rapid freezing or thawing of a biomaterial within the biocontainer. Specifically, the heat transfer into or out of a biocontainer may be limited by a type of material and/or an amount of material forming the biocontainer. While the type of material or the amount of material may be selected to prevent damage to the biocontainer during filling, freezing, storage, thawing, and transport, the type of material or the amount of material forming the biocontainer may prevent or inhibit rapid freezing or thawing of a biomaterial disposed within the biocontainer.

In some applications, biocontainers are handled by hand, equipment, or machines before, during, or after freezing. The handling of the biocontainers can damage the biocontainers if the material forming the biocontainer is brittle. In addition, when handling by machines, there is a need for a uniform shape and size to allow for the machine to move the biocontainer without damaging the biocontainer.

In some applications, a flexible bag is used as a biocontainer. Such flexible bags allow for rapid heat transfer into or out of a biomaterial within the bag. However, as noted above, these flexible bags may become brittle when frozen. Additionally, these flexible bags may change shape as biomaterial disposed therein is frozen making the flexible bags difficult to handle. Additionally, these flexible bags may be difficult to stack or store due to an irregular shape of the flexible bags when the biomaterial is frozen therein.

There is therefore a need for biocontainers that can be cryogenically frozen without damage. There may be a need for biocontainers that can be handled by machines or equipment without being damaged. There may be a need for biocontainers that have a uniform shape when frozen to allow for condensed and/or simplified storage.

### SUMMARY

This disclosure relates generally to a semi-rigid biocontainer for storing biopharmaceutical compositions. The biocontainers disclosed herein may have a uniform shape that allow for the biocontainers to be manipulated by machines or equipment without being damaged. In some embodiments, the biocontainers may remain sealed at cryogenic temperatures.

In an embodiment of the present disclosure, a biocontainer includes a rigid frame and a flexible membrane. The rigid frame includes a latticed core. The flexible membrane is attached to the frame and forms a sealed interior of the biocontainer.

In embodiments, the biocontainer includes a first tube that extends through the frame and is in fluid communication with the interior of the biocontainer. The biocontainer may include a second tube that extends through the frame and in fluid communication with the interior of the biocontainer. The first tube may be formed of a thermoset material, e.g., silicone, and the second tube may be formed of a thermoplastic material. The first tube and the second tube may be sealingly attached to the frame. The first tube or the second tube may be over-molded to the frame.

In some embodiments, the biocontainer remains sealed to at least −180° C. or −196° C. At least a portion of the frame may be disposed within the interior of the biocontainer. The entire frame may be within the interior of the frame.

In certain embodiments, the frame may form an exoskeleton of the biocontainer. The frame may include a stacking feature on a major surface of the frame. The stacking feature may be configured to receive a stacking feature of another biocontainer.

In particular embodiments, the frame may be encapsulated within a sheath. The membranes may be attached to the sheath. The sheath forms a portion of an interior of the biocontainer.

In another embodiment of the present disclosure, a method of manufacturing a biocontainer includes forming a rigid frame having a lattice core and attaching a flexible membrane to the frame to seal an interior of the biocontainer.

In embodiments, forming the frame includes over-molding the lattice core. Forming the frame may include forming the frame via additive manufacturing techniques.

In some embodiments, forming the frame may include encapsulating the core with a sheath. Attaching the membrane to the frame may include bonding the membrane to the sheath.

In certain embodiments, securing a first tube and a second tube to the frame such that the first tube and the second tube are fixed relative to the frame. Securing the first tube and the second tube may include over molding the first tube and the second tube. Securing the first tube and the second tube may include the first tube being a thermoset tube, e.g., a silicone tube, and the second tube being a thermoplastic tube.

In particular embodiments, attaching the flexible membrane may include attaching the flexible membrane to an inner surface of the frame such that the frame forms an exoskeleton of the flexible membrane.

In another embodiment of the present disclosure, a method of storing a biopharmaceutical composition includes loading a biocontainer with biopharmaceutical composition and cryogenically freezing the biocontainer containing the biopharmaceutical composition.

Further, to the extent consistent, any of the embodiments or aspects described herein may be used in conjunction with any or all of the other embodiments or aspects described herein.

### BRIEF DESCRIPTION OF THE DRAWINGS

Various aspects of the present disclosure are described hereinbelow with reference to the drawings, which are incorporated in and constitute a part of this specification, wherein:

FIG. 1 is a top view of a biocontainer provided in accordance with an embodiment of the present disclosure;

FIG. 2 is an enlarged top view of the biocontainer of FIG. 1;

FIG. 3 is a side, perspective view of the biocontainer of FIG. 1;

FIG. 4 is a top view of a mold provided in accordance with an embodiment of the present disclosure;

FIG. 5 is a top view of the mold of FIG. 4 with a frame formed within the mold;

FIG. 6 is a flow chart of a method provided in accordance with the present disclosure;

FIG. 7 is top view of another biocontainer provided in accordance with an embodiment of the present disclosure with membranes formed on an inside of the frame; and

FIG. 8 is a top view of the biocontainer of FIG. 9 with membranes formed on an outside of the frame.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like. As used in the specification and the appended claims, the term “cryogenic” refers to temperatures at or below −20° C. and refers to temperatures generally in a range of −20° C. to −196° C. Further, as used herein the term “biopharmaceutical compositions” refers to a product coming from biotechnology, culture environments, cell cultures, buffer solutions, artificial nutrition liquids, blood products and derivatives of blood products, a pharmaceutical product, or more generally a product intended to be used in the medical field including, without any limitation, monoclonal antibodies (mAbs), therapeutic proteins, viruses including lipid nanoparticles vaccines and virus banks, exosomes, cell banks, and cell therapy products.

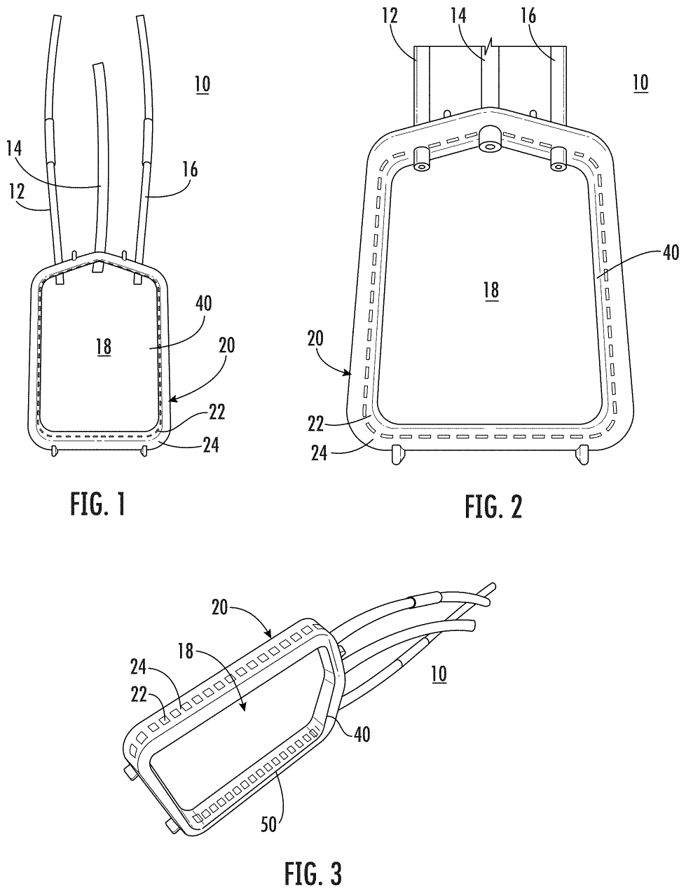

Referring now to FIGS. 1-3, a semi-rigid biocontainer 10 is provided in accordance with an embodiment of the present disclosure. The biocontainer 10 has a defined shape and includes tubing connections 12, 14, 16 that allow for the flow of material into an interior 18 of the biocontainer 10. The junctions or connections of the tubes may be over-molded, adhesively attached, or mechanically fastened to sealingly attach thermoset tubing, e.g., silicone tubing, and/or thermoplastic tubing, e.g., PVC, polyolefin, TPE, to the biocontainer 10. In some embodiments, a single biocontainer 10 may include both thermoset and thermoplastic tubing. The biocontainer 10 may be relatively thin with a length and a width significantly greater than a thickness similar to a traditional fluid bag. The dimensions of the biocontainer 10 may allow for uniform and rapid heat transfer into and out of the biocontainer 10. The dimensions of the biocontainer 10 may allow for long term storage of biomaterial within the biocontainer 10.

The defined shape of the biocontainer 10 may allow for simplified handling of the biocontainer 10 by equipment, machines, or by hand. The simplified handling of the biocontainer 10 may allow for increased automation of filling, freezing, storing, thawing, and/or emptying of the biocontainer 10. The defined shape of the biocontainer 10 may allow for simplified storage and/or stacking of multiple biocontainers 10. For example, when a flexible bag is used to store biomaterial, it may be difficult to stack multiple flexible bags as the shape of each of the respective flexible bags may differ from adjacent bags. In contrast, the defined shape of the biocontainer 10 may allow for stacking multiple biocontainers 10. The defined shape of the biocontainer 10 may provide a defined or known volume of the biocontainer 10. The defined or known volume of the biocontainer may ease determination of volume of biomaterial within the biocontainer 10.

The biocontainer 10 includes a rigid frame 20 and flexible membranes 40. The rigid frame 20 defines the dimensions of the biocontainer 10 and supports the membranes 40. The rigid frame 20 defines the shape of the biocontainer 10. The frame 20 includes a core 22 that may be formed of a rigid lattice structure that defines the shape of the frame 20, and thus, the shape of the biocontainer 10. The rigid lattice structure may minimize an amount of material forming the frame 20 while providing a rigid structure. In some embodiments, the core 22 is encapsulated within a sheath 24. The sheath 24 may partially form a seal for the interior 18 of the biocontainer 10. In some embodiments, portions of the sheath 24 may be configured to contact biomaterial disposed within the biocontainer 10. The sheath 24 may prevent the core 22 or portions thereof from being contacted by biomaterial within the biocontainer 10. In certain embodiments, the sheath 24 may be compatible with the membranes 40 such that the membranes 40 or the sheath 24 may be locally melted to bond the membranes 40 to the frame 20.

The entire frame 20 or portions thereof may be disposed within the interior 18 of the biocontainer. In some embodiments, the entire frame 20 or portions thereof may be outside of the interior 18. Portions of the frame 20 disposed outside of the interior 18 may be considered an exoskeleton of the biocontainer 10. Portions of the frame 20 disposed within the interior 18 may be considered an inner frame of the biocontainer 10.

When the frame 20 includes an inner frame, the inner frame may form a lattice structure. The lattice structure of the inner frame may have a void volume of greater than 75% to maximize a storage volume of the biocontainer 10. In some embodiments, a thickness of the lattice structure is minimized to maximize a storage volume of the biocontainer 10. In certain embodiments, the inner frame is formed of the core 22 of the frame 20. In particular embodiments, portions of the core 22 may be configured to contact biomaterial within the biocontainer 10.

Portions of the frame 20, including the core 22 or the sheath 24, may include a variety of materials including thermosets or thermoplastics. In some embodiments, portions of the frame 10 are formed of resin based thermosets such as Carbon including CE221 or MPU100. In certain embodiments, portions of the frame 10 are formed by selective laser sintering (SLS) of nylon, polyether ether ketone (PEEK), polyolefin, polytetrafluoroethylene (PTFE) or other thermoplastics. In some embodiments, portions of the frame 20 may be metalized. Metalizing portions of the frame 20 may increase heat transfer into or out of the biomaterial stored within the biocontainer 10. In some embodiments, metalizing portions of the frame 20 may allow for induction heating of a biomaterial within the biocontainer 10. In certain embodiments, metalizing portions of the frame 20 may increase stiffness of the frame 20. In particular embodiments, metalizing the frame 20 may increase an inertness of the frame 20 and/or a purity of a biomaterial disposed within the biocontainer 10.

In embodiments, portions of the frame 20 may be formed of additive manufacturing techniques. Forming the frame 20 by additive manufacturing techniques may allow for increased adhesion or bonding of the membranes to the frame 20 as detailed below. In certain embodiments, the core 22 is formed of additive manufacturing techniques in a manner to increase adhesion or bonding of the sheath 24 and/or the membranes 40 to the core 22. In embodiments, the core 22 or the sheath 24 of the frame 20 may be molded.

The membranes 40 may be adhered or bonded to the rigid frame 20 to form the interior 18 of the biocontainer 10. In some embodiments, the interior 18 of the biocontainer 10 is defined between the membranes 40. In some embodiments, portions of the interior 18 are defined by the frame 20 disposed between the membranes 40.

The membranes 40 may be formed of a flexible material that conforms to volume changes of biomaterial disposed within the interior 18 of the biocontainer 10. The membranes 40 may be formed of or include a thermoset material or a thermoplastic material. For example, the membranes 40 may include silicone and/or thermoplastic. In some embodiments, the membrane 40 includes a microporous material for lyophilization or improved oxygen or carbon dioxide transport into or out of the biocontainer 10. Improved oxygen or carbon dioxide transport may improve cell growth within the biocontainer 10.

In some embodiments, the membranes 40 may be composite membranes with a first side formed of a first material and a second side formed of a second material. In certain embodiments, a composite membrane 40 may include a thermally conductive silicone as an exterior surface laminated to a pure silicone membrane that forms the inner surface. In some embodiments, a composite membrane 40 includes an electrically conductive silicone laminated to a pure silicone membrane for induction heating of biomaterial within the biocontainer 10.

The membranes 40 may be uniform on both sides of the biocontainer 10 or may be different on each side of the biocontainer 10. In certain embodiments, each membrane 40 may be of uniform construction. In particular embodiments, portions of the membrane 40 may have a different construction from other portions of the membrane 40. For example, one or more portions of a membrane 40 may include a thermally conductive silicone, an electrically conductive silicone, or a microporous material. In embodiments, the membrane 40 may include a silicone rubber having a thickness in a range of 0.01 mm to 3 mm, e.g. 1 mm. The membrane 40 may be formed of a silicone having any hardness. In some embodiments, the membranes 40 may be formed of a silicone having a Shore A hardness in a range of 30-80. As noted above, the membrane 40 may be a silicone rubber calendared into multilayer films including a thermally conductive layer on the exterior side and a silicone with a Shore A hardness in a range of 30-80 on the biomaterial contact side, e.g., the inside surface. The membrane 40 may be a multilayer film with an electrically conductive film on the exterior surface for induction or RF heating of a biomaterial within the container and a film with a Shore A hardness in a range of 30-80 on an inside surface. The membrane 40 may be rubber cast onto an expanded polytetrafluoroethylene (ePTFE) film or microporous membrane, e.g. polyethersulfone (PES), polypropylene (PP), etc. In some embodiments, the membrane 40 may be silicone rubber cast onto a non-woven film. The membranes 40 may be perfluoropolyether (PFPE) rubber calendared into sheet form. The membranes may be a TPE membrane that may be attached with EPE adhesive, e.g., Santoprene™ 8291 TB. The membranes 40 may be a nylon, a PE material, a cyclo olefin polymer such as Zeonex, metalized plastic films, glass coated plastic films, PEEK, PES, a polyetherimide (PEI) such as Ulterm, a polyimide (PI) material such as Kapton. The membranes 40 may be functionalized film to improve crystal structure of frozen product or to interact with the biomaterial stored within the biocontainer 10.

The membranes 40 may be attached, bonded, or adhered to the frame 20. In some embodiments, the membranes 40 may be adhered with a LIM™ 8040 available from Momentive Performance Materials or another platinum catalyzed silicone adhesive. In some embodiments, the frame 20 and the membranes 40 are compatible with one another such that the frame 20 and the membranes 40 may be bonded by locally melting the frame 40 and/or the membranes 40 together. In some embodiments, the frame 20 may be molded about the membranes 40 such that the frame 20 is bonded to the membranes 40. In certain embodiments the frame 20 is compatible with an outer surface of the membranes 40 and incompatible with an inner surface of the membranes 40 and in other embodiments, the frame 20 is compatible with the inner surface of the membranes 40 and incompatible with an outer surface of the membranes 40.

The biocontainer 10 may include one or more embedded sensors 50. The sensors 50 may monitor a temperature of biomaterial disposed within the biocontainer 10. In certain embodiments, the biocontainer 10 includes a thermowell for temperature monitoring. The thermowell may be positioned to be a leading indicator of a temperature change of a biomaterial or may be positioned to be a trailing indicator of a temperature change of a biomaterial.

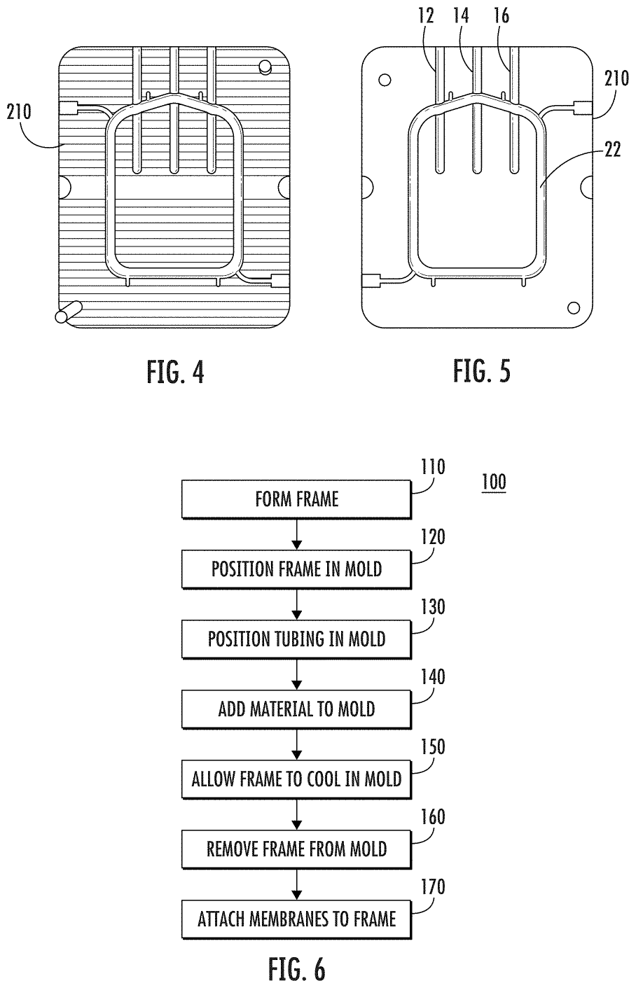

Referring now to FIGS. 4-6, a method of manufacturing a biocontainer is disclosed in accordance with an embodiment of the present disclosure and is referred to generally as method 100. While the method 100 may be used to form a variety of biocontainers, the method 100 is described herein with reference of the biocontainer 10 of FIGS. 1-3. The method 100 may include forming the frame 20 (Step 110). Forming the frame 20 may include molding the core 22 of the frame 20 or producing the core 22 via additive manufacturing techniques. The core 22 may include a latticed structure. The latticed core 22 may reduce an amount of material forming the frame 20. With the core 22 formed, the core 22 is positioned in a mold 210 as shown in FIGS. 4 and 5 (Step 120).

The method 100 may include positioning tubing 12, 14, 16 in mold 210 (Step 130). The tubing 12, 14, 16 may be silicone tubing and/or TPE tubing. In certain embodiments, at least one of the tubes 12, 14, 16 is a silicone tube and at least one of the tubes 12, 14, 16 is a TPE tube. Each tube of the tubing 12, 14, 16 may pass through an opening in the core 22. With the tubing 12, 14, 16 positioned in the mold 210, the mold 210 is closed and material is poured into or injected into the mold 210 to encapsulate the core 22 of the frame 20 within the sheath 24 (Step 140). The material poured or injected into the mold 210 to form the sheath 24 may be silicone. After the material is poured into the mold 210, the material is allowed to cure or cool within the mold to form the frame 20 and/or to bond the tubing 12, 14, 16 to the frame 20 (Step 150). As the material is poured into the mold 210, the material forming the frame 20, may bond to the tubing 12, 14, 16. For example, the tubing 12, 14, 16 may be over-molded to secure and seal the tubing 12, 14, 16 to the frame 20. By over-molding the tubing 12, 14, 16, multiple types of tubing may be used with the method 100 to form the biocontainer 10. When the material encapsulating the core 22 forming the sheath 24 is cooled, the mold 210 is opened and the completed frame 20 including the tubing 12, 14, 16 is removed from the mold 210 (Step 160).

When the frame 20 is completed, the membranes 40 are attached to the frame 20 to form and seal the interior 18 of the biocontainer 10 (step 170). The membranes 40 may be adhered or bonded to the frame 20. In some embodiments, the membranes 40 include a silicone layer that is adhesively adhered to a silicone of the frame 20. The membranes 40 and the frame 20 may form an all silicone contact surface for the interior 18 of biocontainer 10. In certain embodiments, the membranes 40 may be formed by casting silicone onto a carrier film. The carrier film may be a PET Film, a PES film, or a polycarbonate film. In some embodiments, the membranes 40 may be bonded to the frame 20. In certain embodiments, the membranes 40 and/or the portions of the frame 20 are locally melted to bond the membranes 40 to the frame 20. The membranes 40 may be joined to an inside of the frame 20 with the frame 20 forming an exoskeleton for the membranes 40 or the membranes 40 may be joined to an outside of the frame 20 such that portions of the frame 20 are disposed in the interior 18.

The method 100 is one example of a method for forming a biocontainer, e.g., biocontainer 10. In some embodiments, portions of the frame 20 may be formed by additive manufacturing techniques, e.g., three-dimensional printing, or molding. In certain embodiments, portions of the frame 20 may be formed separate from the membranes 40. In such embodiments, the membranes 40 may be adhered to the frame 20 by use of one or more adhesives.

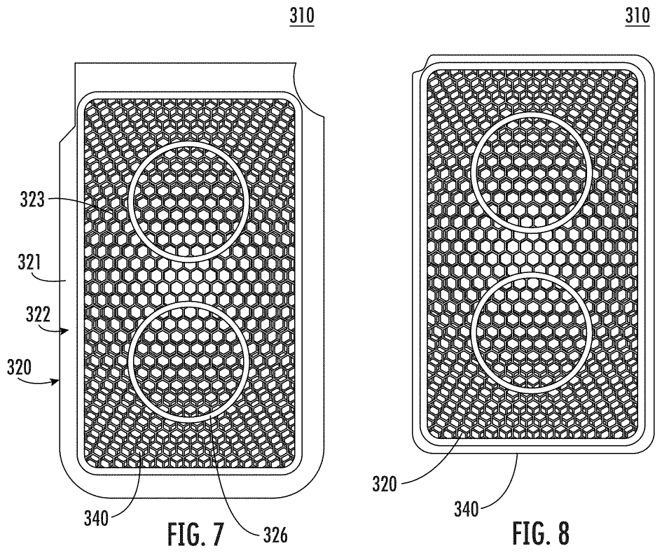

Referring now to FIGS. 7 and 8, another biocontainer 310 is disclosed in accordance with an embodiment of the present disclosure. The biocontainer 310 includes a frame 320 and membranes 340. Elements of the biocontainer 310 may be similar to elements of the biocontainer 10 detailed above with respect to FIGS. 1-3 and are represented with similar labels with a preceding 3. As such, aspects of the biocontainer 310 will not be described in detail except for the differences with the biocontainer 10.

The frame 320 of the biocontainer 310 may include a core 322 having edge portions 321 and a central portion 323. The edge portions 321 are rigid to define at least two dimensions of the biocontainer 310, e.g., the width and the length. In some embodiments, the edge portions 321 define the width, the length, and the thickness of the biocontainer 310. As shown, the edge portions 321 may be substantially solid. In some embodiments, the edge portions 321 may include a lattice to reduce an amount of material forming the edge portions 321. The frame 320 may be formed via molding or additive manufacturing techniques. In some embodiments, the frame 320 is molded such that tubing (not explicitly shown) is over-molded to secure the tubing to the frame 320.

The central portion 323 may form a lattice that extends between opposite edges of edge portions 321 of the frame 320. The lattice of the central portion 323 may be rigid such that the central portion 323 maintains its dimensions or may be flexible such that the central portion 323 may flex when a force is applied. In certain embodiments, the central portion 323 may flex inward to decrease a thickness of the biocontainer 310 or may flex outward to increase a thickness of the biocontainer 310. The flexing of the central portion 323 may be in response to an increase or decrease in a volume of a biomaterial stored within the biocontainer 310. In certain embodiments, the central portion 323 may include a stacking or reinforcement feature 326. In particular embodiments, a central portion 323 on a first side of the biocontainer 310 may have a stacking feature 326 having a first dimension and a central portion 323 on the second opposite side of the biocontainer 310 may have a stacking feature 326 having a second dimension that is sized to complement the stacking feature 326 on the first side of the biocontainer 310. For example, when the biocontainer 310 is stacked with other biocontainers 310, the stacking features 326 may aid in stacking biocontainers 310 to allow for an increased number of biocontainers 310 to be stacked together.

As shown, the membranes 340 of the biocontainer 310 are adhered or bonded to an internal surface of the frame 320 such that the frame 320 acts as an exoskeleton. In some embodiments, the membranes 340 may be adhered to or bonded to an outside surface of the frame 320 with the frame 320 disposed inside the membranes 340. The membranes 340 may be adhered to the frame 320 such that the membranes 340 may flex into or away from the frame 320. The flexing of the membranes 340 may allow for the membranes 340 to adjust to a volume of a biomaterial contained within the biocontainer 310.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

1. A biocontainer comprising:
a rigid frame, the frame including a lattice core; and
a flexible membrane attached to the frame, the flexible membrane forming a sealed interior of the biocontainer.

2. The biocontainer according to claim 1, further comprising a first tube extending through the frame and in fluid communication with the interior of the biocontainer.

3. The biocontainer according to claim 2, further comprising a second tube extending through the frame and in fluid communication with the interior of the biocontainer, the first tube formed of a thermoset material and the second tube formed of a thermoplastic material, the first tube and the second tube sealingly attached to the frame.

4. The biocontainer according to claim 3, wherein the first tube or the second tube are over-molded to the frame.

5. The biocontainer according to claim 1, wherein the biocontainer remains sealed to at least −196° C.

6. The biocontainer according to claim 1, wherein at least a portion of the frame is disposed within the interior of the biocontainer.

7. The biocontainer according to claim 6, wherein the entire frame is within the interior of the biocontainer.

8. The biocontainer according to claim 1, wherein the frame forms an exoskeleton of the biocontainer.

9. The biocontainer according to claim 1, wherein the frame includes a stacking feature on a major surface of the frame, the stacking feature configured to receive a stacking feature of another biocontainer.

10. The biocontainer according to claim 1, wherein the lattice core of the frame is encapsulated within a sheath.

11. The biocontainer according to claim 10, wherein the flexible membrane is attached to the sheath.

12. The biocontainer according to claim 11, wherein the sheath forms a portion of an interior of the biocontainer.

13. A method of storing biopharmaceutical composition, the method comprising:
loading a biocontainer according to claim 1 with biopharmaceutical composition; and
cryogenically freezing the biocontainer containing the biopharmaceutical composition.

14. A method of manufacturing a biocontainer, the method comprising:
forming a rigid frame having a lattice core; and
attaching a flexible membrane to the frame to seal an interior of the biocontainer.

15. The method according to claim 14, wherein forming the frame includes over-molding the lattice core.

16. The method according to claim 14, wherein forming the frame includes forming the frame via additive manufacturing techniques.

17. The method according to claim 14, wherein forming the frame includes encapsulating the lattice core with a sheath.

18. The method according to claim 17, wherein attaching the flexible membrane to the frame includes bonding the flexible membrane to the sheath.

19. The method according to claim 14, further comprising securing a first tube and a second tube to the frame such that the first tube and the second tube are fixed relative to the frame.

20. The method according to claim 19, wherein securing the first tube and the second tube includes the first tube being a thermoset tube and the second tube being a thermoplastic tube.
